(19) United States
(12) Patent Application Publication
(10) Pub. No.: US 2016/0215931 A1
(43) Pub. Date: Jul. 28, 2016

(54) ACTUATOR DETECTOR DEVICE

(71) Applicant: BARNBROOK SYSTEMS LIMITED, Fareham Hampshire (GB)

(72) Inventors: Andrew BARNETT, Hampshire (GB); Keith SMITH, Hampshire (GB)

(21) Appl. No.: 14/915,381

(22) PCT Filed: Feb. 28, 2014
(86) PCT No.: PCT/GB2014/052605

§ 371 Date: Feb. 29, 2016

(30) Foreign Application Priority Data
Aug. 28, 2013 (GB) 1315316.8

(51) Int. Cl. F17C 13/02; A62C 37/50

(52) U.S. Cl. CPC F17C 13/02; A62C 37/50

(57) ABSTRACT

An actuator detector device (1) for detecting whether an actuator for a fluid container is correctly fitted to the container, the detector device comprises a switch (6) to detect the presence of a fitted actuator, which switch is arranged to be depressed when the actuator is correctly in place, and the device further comprises an attachment (2) to attach the device in position.

### TECHNICAL FIELD

The present invention relates generally to actuator detectors.

### BACKGROUND

For some safety measures, for example, fire safety, a vessel or container (which may be referred to as a bottle) containing a fluid is provided with an actuator which causes the fluid to be released from the container. For example, the container may include a fire extinguisher fluid, and upon detection of a fire, the actuator is caused (automatically or manually) to release the fluid within. It is possible that during installation or maintenance that the actuator may not be correctly fitted to the container and in some instances, may not have been fitted at all. This then creates a risk that the fluid will not be expelled when it is required.

We have devised a detector device which is operative to provide an indication that the actuator has been correctly fitted to the container.

### SUMMARY

According to the invention there is provided an actuator detector device for detecting whether an actuator for a fluid container is correctly fitted to the container. The detector device may comprise a switch to detect the presence of a fitted actuator, which switch is arranged to be depressed when the actuator is correctly in place, and the device may further comprise an attachment to attach the device in position.

The attachment may be arranged to be located by way of clamping between the actuator and fluid container.

The attachment may be arranged to be clamped between opposing surface portions of the actuator and the container respectively.

The attachment may comprise a clip.

The attachment may comprise a portion which is arranged to fit around a threaded element of either the fluid container or the actuator. The threaded portion is preferably arranged to enable the actuator to be connected to fluid container.

The device may be arranged to be detachably connectable.

The attachment may be arranged to grip around a part of the actuator or the fluid container.

The attachment may be of substantially C-shape when viewed in plan.

The attachment may comprise a seating surface which is arranged to receive an actuator.

The switch may comprise a slideable switch arranged to engage with the actuator, at at least a surface portion thereof.

The switch may comprise an inclined contact surface for operative engagement with the actuator.

Reference to fluid used herein covers both liquid and gaseous phases.

Other aspects of the invention may relate to a combination of any of the above features, and/or any of the features below or in the drawings.

### BRIEF DESCRIPTION OF THE DRAWINGS

Various embodiments of the invention will now be described, by way of example only, with reference to the following drawings in which:

FIG. 1 is a perspective view of an actuator detector switch,

FIG. 2 is a plan view of the actuator detector of FIG. 1,

FIG. 3 is a side view of the actuator detector of FIG. 1,

FIG. 4 is a front elevation of the actuator detector of FIG. 1,

FIG. 5 is a perspective view of an actuator being attached to a fluid container, and

FIG. 6 is a perspective view of an actuator attached to a fluid container.

### DETAILED DESCRIPTION

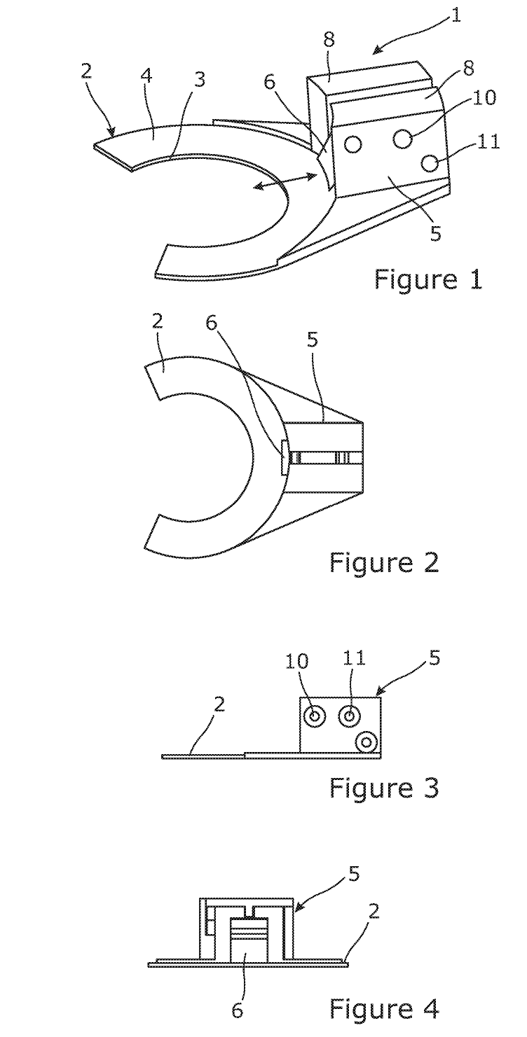

With reference to FIG. 1 there is shown an actuator detector, which is arranged to determine when an actuator has been correctly fitted to a fluid container, such as a bottle. The fluid container may be of the type which contains fire extinguisher fluid. The actuator serves to control/regulate the fluid being expelled from the container.

The detection device is arranged to be fitted to a fluid container, and in particular the valve of the container, such that when an actuator is attached thereto, a switch in the detector device senses that the actuator has been attached, and moreover that the actuator has been correctly attached.

The detector may be view as comprising two components—an attachment to attach the detector in place and a switch to detect when the actuator has been correctly installed.

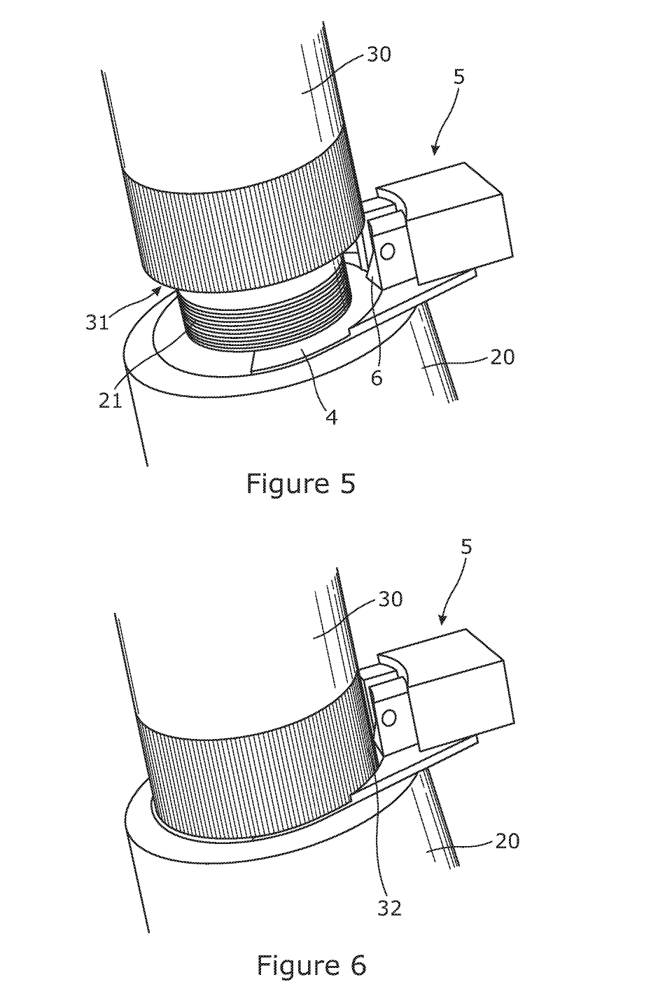

The attachment comprises a clip 2 which is essentially of C-shape when viewed in plan. An inner surface 3 of the attachment is arranged to engage with a portion of the valve of the container. The construction of the attachment is such that it includes some inherent flexibility to the extent that the two limbs there can be resiliently moved apart sufficient to allow the attachment to fit around the valve. By gripping the valve in this way ensures that the detector can be detachably connected to the valve. As shown in FIG. 5, the clip has been urged to fit around the valve and retain the detector in position. In this case, the inner surface 3 engages with the thread of the valve.

The clip 2 is provided with a flat upper surface 4 which is arranged to receive a contact surface of the actuator.

The second sub-assembly of the switch is shown generally in the drawings by reference numeral 5, which is the switch assembly. The assembly 5 is positioned at a peripheral region of the clip 2, and comprises a switch device which is responsive to the presence of the actuator when fitted correctly.

The switch device comprises a plunger component 6 which is mounted for translational movement, as indicated by the double-headed arrow in FIG. 1. The engagement surface of the plunger component is angled so as to facilitate the switching response when coming into engagement with the actuator. The plunger component is mounted in a housing which comprising two portions 8 which flank the plunger component. The switch can be arranged to be in a normally ON or normally OFF condition, but in either case movement of the plunger component between the two switched conditions causes electrical contacts within the housing to be made or broken.

Connection to external equipment, such as a control centre, is achieved by way of wiring which extends from the housing at 10 and 11. This could allow monitoring to be achieved wherein one or more signals could be generated depending on whether it is determined that the actuator is correctly installed. If it were determined that the actuator were not correctly installed, an alarm signal could be raised to ensure that corrective action is taken (i.e. to correctly fit the actuator).

Further reference is now made to FIG. 5, and to FIG. 6, which shows the method of installation of the detector. In use, and in the contact of a fire extinguisher system, prior to the actuator being installed, the detector 1 is attached to a threaded portion 20 of an outlet of a valve of a fire extinguisher container 21. For such a system, fluid from the container is released from the container on receipt of a signal to the actuator. Such a signal may be generated by way of an automated fire detection system.

The detector is held up to the base of the threaded portion and urged theretowards. In so doing, the limbs of the clip 2 of the detector resilient flex/deflect apart so as to allow attachment of the clip to the valve. Once the limbs have been caused to pass beyond the widest point of the valve, the inherent resilience of the limbs causes them to return to their initial position, and thereby grip around the threaded portion. In so doing, the inner surface 3 is brought into engagement with the threaded potion.

The actuator 30 may now be fully attached to the valve. In so doing the user rotates the actuator so as to urge the actuator downwards towards the valve, and towards the detector. Eventually, a lower surface 31 of the actuator comes into engagement with the surface 4 of the clip, and clamps the detector between the valve and the actuator. In this ‘home’ position a portion of the lower margin 32 of the actuator engages with the inclined surface and urges the plunger component 6 inwards of the housing 5. Only when the actuator has been rotated sufficiently downwardly will the plunger be moved sufficiently to change the switch condition, and thereby indicate that the actuator is correctly fitted.

1. An actuator detector device for detecting whether an actuator for a fluid container is correctly fitted to the container, the detector device comprising a switch to detect the presence of a fitted actuator, which switch is arranged to be depressed when the actuator is correctly in place, the device further comprising an attachment to attach the device in position.

2. A device according to claim 1 in which the attachment is arranged to be located by way of clamping between the actuator and fluid container.

3. A device according to claim 1 which is arranged to be clamped between opposing surface portions of the actuator and the container respectively.

4. A device according to claim 1 in which the attachment comprises a clip.

5. A device according to claim 1 in which the attachment comprises a portion which is arranged to fit around a threaded element of either the fluid container or the actuator.

6. A device according to claim 5 in which the threaded portion is arranged to enable the actuator to be connected to fluid container.

7. A device according to claim 1 which is arranged to be detachably connectable.

8. A device according to claim 1 in which the attachment is arranged to grip around a part of the actuator or the fluid container.

9. A device according to claim 1 in which the attachment is of substantially C-shape when viewed in plan.

10. A device according to claim 1 in which the attachment comprises a seating surface which is arranged to receive an actuator.

11. A device according to claim 1 in which the switch comprises a slideable switch arranged to engage with the actuator, at at least a surface portion thereof.

12. A device according to claim 1 in which the switch comprises an inclined contact surface for operative engagement with the actuator.
